(19) United States
(12) Patent Application Publication
(10) Pub. No.: US 2023/0292044 A1
(43) Pub. Date: Sep. 14, 2023

(54) AUDIO SIGNAL PROCESSING APPARATUS, AUDIO SYSTEM, AND METHOD FOR ENHANCING LOW-FREQUENCY SOUND SENSATION

(71) Applicant: Alps Alpine Co., LTD., Tokyo (JP)

(72) Inventor: Ryosuke TACHI, Iwaki (JP)

(73) Assignee: Alps Alpine Co., LTD., Tokyo (JP)

(21) Appl. No.: 18/113,238

(22) Filed: Feb. 23, 2023

(30) Foreign Application Priority Data
Mar. 8, 2022 (JP) 2022-035056

(51) Int. Cl. H04R 3/04

(52) U.S. Cl. CPC H04R 3/04

(57) ABSTRACT

One form of an audio signal processing apparatus adds a low-frequency sound sensation enhancement signal for enhancing a low-frequency sound sensation of an audio source signal to the audio source signal output by an audio source device, and outputs a resultant signal to a loudspeaker. The audio signal processing apparatus generates the low-frequency sound sensation enhancement signal with a frequency range from f0 to f1 (where f0<f1) by contraction mapping of components in a frequency range lower than f0 of the audio source signal using FIF (Fractal Interpolation Functions) where f0 is a frequency at a lower limit of a reproduction frequency range of the loudspeaker.

### BACKGROUND

The present application claims priority to Japanese Patent Application Number 2022-035056, filed Mar. 8, 2022, the entirety of which is hereby incorporated by reference.

### BACKGROUND

### 1. Field of the Disclosure

The present disclosure relates to a technique for enhancing a sensation of a low-frequency sound output by an audio system.

### 2. Description of the Related Art

In a case where a loudspeaker having insufficient reproduction capability in a low frequency range, such as a small and lightweight speaker, is used as an output device in an audio system, a low-frequency sound sensation that a user perceives may be insufficient. To address such a situation, techniques are known for enhancing the sensation of the low-frequency sounds. In one such technique, low-frequency signal components output from an audio source apparatus are divided into a plurality of frequency bands, and overtones of signal components in each divided frequency band are generated. The generated overtones are added to the original signal output from the audio source apparatus, and a resultant signal is output to a loudspeaker (see, for example, JP 2004-320516 A).

As another such technique, a FIF (Fractal Interpolation Functions) technique is known (see, for example, JP 2005-084370 A, JP 2006-330144 A, or JP 2009-229492 A). In the FIF technique, a time interval T is divided into a plurality of time intervals referred to as interpolation intervals ti, and a contraction mapping function ωi(S), that maps a signal waveform S in the time interval T into the interpolation intervals ti, is calculated whereby audio data is up-sampled by contraction mapping of the signal waveform S into each interpolation interval ti the using contraction mapping function ωi(S).

### SUMMARY

In the above-described technique for enhancing the low-frequency sound sensation by adding overtones of each frequency band of the low-frequency components of the output signal from the audio source apparatus to the output signal, since only the overtones are added to the output signal, there is a possibility that the sound output by the loudspeaker provides an unnatural feeling depending on the type of the sound represented by the signal output by the audio source apparatus (for example, a simple effect sound).

In view of the above, it is an objective of the present disclosure to provide a technique for enhancing the low-frequency sound sensation of a sound output by an audio system such that a more natural sound sensation is achieved.

In order to address the above objective, the present disclosure provides an audio signal processing apparatus configured to add, to an input audio signal, a low-frequency sound sensation enhancement signal for enhancing a low-frequency sound sensation of the audio signal and to output a resultant signal. The audio signal processing apparatus including a low-frequency sound sensation enhancement signal generation unit configured to generate the low-frequency sound sensation enhancement signal from the input audio signal, and a mixing unit configured to mix the low-frequency sound sensation enhancement signal with the input audio signal and to output a resultant mixed signal, wherein the low-frequency sound sensation enhancement signal generation unit is configured to generate the low-frequency sound sensation enhancement signal by contraction mapping of components in a low-frequency range of the input audio signal using Fractal Interpolation Functions (FIF).

Furthermore, in order to address the above objective, the present disclosure provides an audio system including an audio device configured to output an audio signal, a loudspeaker, and an audio signal processing apparatus configured to add, to the audio signal output by the audio device, a low-frequency sound sensation enhancement signal for enhancing a low-frequency sound sensation of the audio signal and to output a resultant signal, wherein the audio signal processing apparatus includes a low-frequency sound sensation enhancement signal generation unit configured to generate the low-frequency sound sensation enhancement signal from the audio signal output by the audio device, and a mixing unit configured to mix the low-frequency sound sensation enhancement signal with the audio signal output by the audio device and output a resultant mixed signal to the loudspeaker. The low-frequency sound sensation enhancement signal generation unit is configured to generate the low-frequency sound sensation enhancement signal with a frequency range from f0 to f1 (where f0<f1) by contraction mapping of components in a frequency range lower than f0 of the audio signal output by the audio device using Fractal Interpolation Functions (FIF) where f0 is a lower limit of a reproduction frequency range of the loudspeaker.

In this audio system, the low-frequency sound sensation enhancement signal generation unit may extract data of the audio signal with a sampling rate of FS output by the audio device such that one piece of data is extracted as a feature point every I pieces of data, and may perform contraction mapping from each feature point in each block with a size BS into each interpolation interval with a size TS obtained by dividing the block such that following relationships are satisfied:

I≥FS(f0×2),

BS≥I×2, and

TS≤BS(f1/f0).

The present disclosure also provides a method for enhancing a low-frequency sound sensation of an audio signal, including a step of generating a low-frequency sound sensation enhancement signal by contraction mapping of a component in a low-frequency range of the audio signal by FIF (Fractal Interpolation Functions), and a step of mixing the low-frequency sound sensation enhancement signal with the audio signal and outputting a resultant mixed signal.

According to forms of the audio signal processing apparatus, the audio system, or the method for enhancing the low-frequency sound sensation, the low-frequency sound sensation is enhanced by using a signal which is in a frequency range higher than the frequency range of the low-frequency components and which has self-similarity to the low-frequency components of the audio signal, and thus it is possible to enhance the low-frequency sound sensation such that a more natural sound sensation can be achieved.

As described above, according to the present disclosure, it is possible to enhance the low-frequency sound sensation of the sound output by the audio system such that a more natural sound sensation is achieved.

### BRIEF DESCRIPTION OF THE DRAWINGS

FIG. 1 is a block diagram illustrating one form of a configuration of an audio system according to an embodiment of the present disclosure;

FIG. 2 is a block diagram illustrating one form of a configuration of a FIF processing unit according to an embodiment of the present disclosure;

FIGS. 3A to 3D are diagrams illustrating examples of processing performed by a FIF processing unit according to an embodiment of the present disclosure;

FIG. 4 is a diagram illustrating an example of processing performed by a FIF processing unit according to an embodiment of the present disclosure;

FIGS. 5A to 5D are diagrams illustrating examples of processing performed by a FIF processing unit according to an embodiment of the present disclosure; and

FIG. 6 is a diagram illustrating an example of processing of generating a low-frequency sound sensation enhancement signal according to an embodiment of the present disclosure.

### DETAILED DESCRIPTION

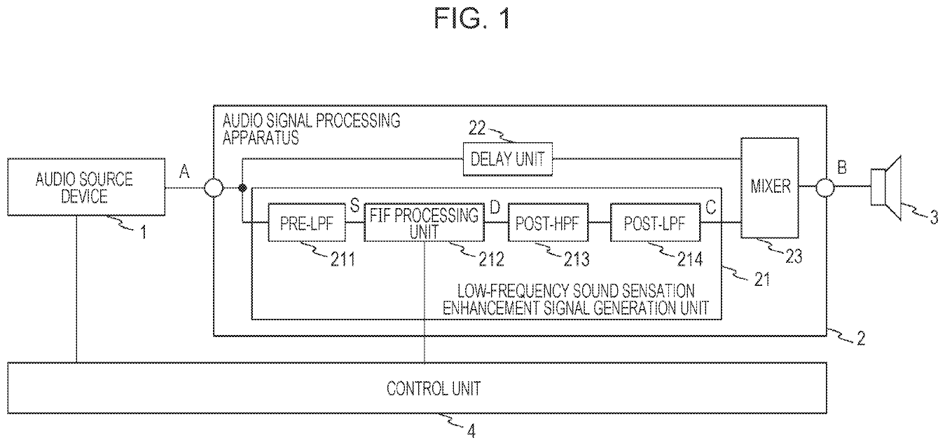

Embodiments and implementations of the present disclosure are described below. FIG. 1 illustrates a configuration of one form of an audio system according to an embodiment of the present disclosure. As illustrated in FIG. 1, the audio system includes an audio source device 1, an audio signal processing apparatus 2, a loudspeaker 3, and a control unit 4. In the audio system configured in this manner, the audio source device 1 outputs an audio source signal A. The audio signal processing apparatus 2 outputs, to the loudspeaker 3, an output audio signal B obtained by adding, to the audio source signal A, a low-frequency sound sensation enhancement signal for enhancing the low-frequency sound sensation of the audio source signal A. The audio signal processing apparatus 2 includes a low-frequency sound sensation enhancement signal generation unit 21 configured to generate and output a low-frequency sound sensation enhancement signal C from the audio source signal A, a delay unit 22 configured to delay the audio source signal A, and a mixer 23 configured to adjust the gain of the output of the low-frequency sound sensation enhancement signal generation unit 21, mix it with the output of the delay unit 22, and output a resultant signal as an output audio signal B. The delay unit 22 delays the audio source signal A by an amount equal to an amount of a delay in the low-frequency sound sensation enhancement signal C.

The low-frequency sound sensation enhancement signal generation unit 21 includes a pre-LPF 211, an FIF processing unit 212, a post-HPF 213, and a post-LPF 214. The low-frequency sound sensation enhancement signal generation unit 21 generates a low-frequency sound sensation enhancement signal C with a frequency range from f0 to f1 (f0<f1) where f0 is a frequency of the lower limit of the reproduction frequency range of the loudspeaker 3. The pre-LPF 211 extracts signal components in the frequency range lower than f0 from the audio source signal A and outputs the extracted signal components as a low-frequency range audio signal S to the FIF processing unit 212. The FIF processing unit 212 performs processing of generating an intermediate low-frequency sound sensation enhancement signal D by the FIF (Fractal Interpolation Functions). The post HPF 213 and post LPF 214 remove unnecessary components in the frequency range lower than f0 and the frequency range higher than f1 from the intermediate low-frequency sound sensation enhancement signal D thereby generating the low-frequency sound sensation enhancement signal C with the frequency range from f0 to f1. The resultant low-frequency sound sensation enhancement signal C is output to the mixer 23.

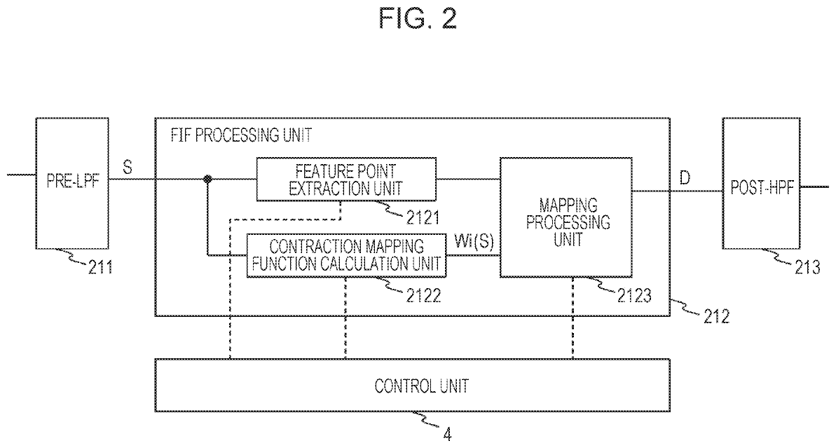

As illustrated in FIG. 2, the FIF processing unit 212 includes a feature point extraction unit 2121, a contraction mapping function calculation unit 2122, and a mapping processing unit 2123. The control unit 4 determines the feature point interval 1, the block size BS of blocks indicating the time intervals, and the interpolation interval size TS of the interpolation intervals obtained by dividing the block into a plurality of pieces, according to the sampling rate FS of the audio source signal A acquired from the audio source device 1 or the like such that following condition is satisfied,

I≥FS(f0×2),

BS≥I×2, and

TS≥BS(f1/f0),

and the control unit 4 sets the determined values in the FIF processing unit 212.

For example, if the sampling rate FS of the audio source signal A is FS=48000 Hz, the lower limit f0 of the reproduction frequency range of the loudspeaker 3 is f0=50 Hz, and the upper limit f1 of the low-frequency sound sensation enhancement signal C is f1=200 Hz, then

I≥S(f0×2)=480.

If I is selected as I=512 for ease of processing, then

BS≥I××2=1024, and

TS≤BS(f1/f0)=256.

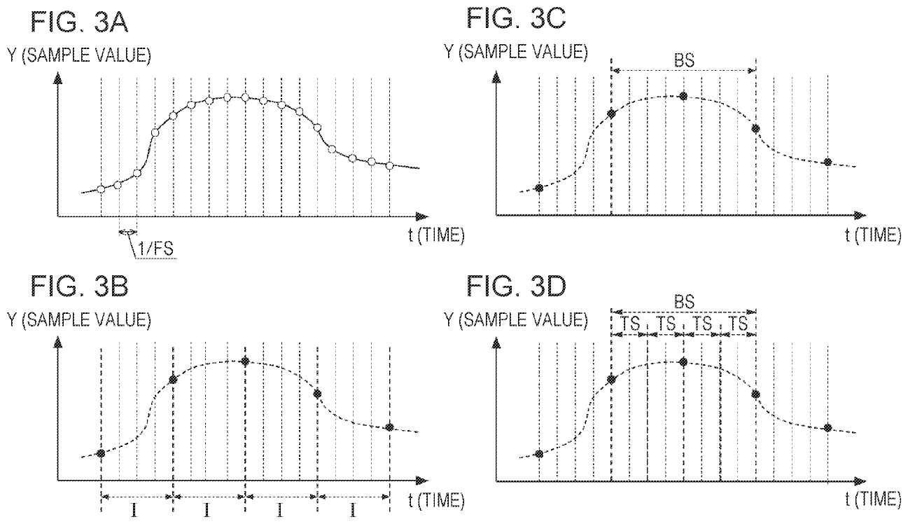

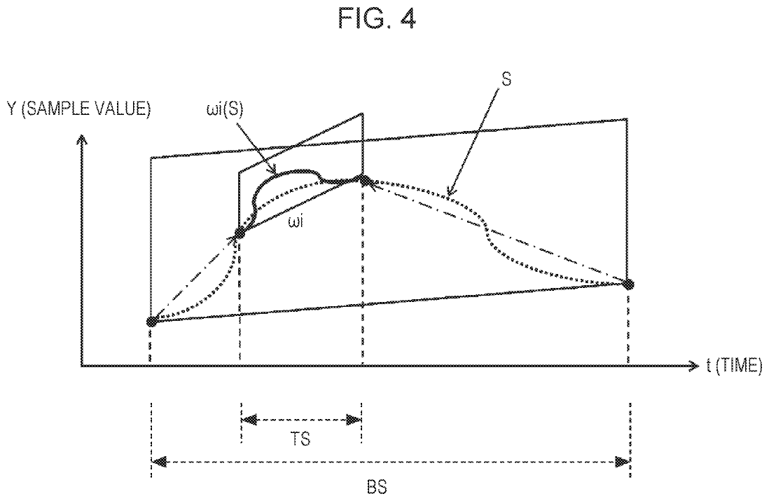

The feature point extraction unit 2121 of the FIF processing unit 212 extracts data of the low-frequency range audio signal S such that one piece of data is extracted as a feature point every I pieces of data. For example, when I=4, the extraction of the low-frequency range audio signal S sampled at a sampling rate of FS as shown in FIG. 3A is performed such that one piece of data is extracted as a feature point every four pieces of data as shown in FIG. 3B. That is, the feature points extracted in the above-described manner are given as a result of down-sampling the low-frequency range audio signal S at a sampling rate of f0×2 or lower, and thus the upper limit of the frequency range of the resultant down-sampled signal is f0 or lower according to the Nyquist's theorem. When the block size BS is set such that BS≥I×2, each block includes 3 or more feature points. For example, when the block size BS=I×2, each block includes 3 feature points as shown in FIG. 3C. When TS is set such that TS≤ft), each block is divided into f1/f0 or more interpolation intervals. For example, when f1/f0=4, each block with a block size BS is divided into four interpolation intervals each having an interpolation interval size equal to BS/4 as shown in FIG. 3D. Next, as shown in FIG. 4, the contraction mapping function calculation unit 2122 calculates the contraction mapping function wi(S) that performs the contraction mapping sequentially for each block with the block size BS of the low-frequency range audio signal S such that the low-frequency range audio signal S of the whole block is mapped into each interpolation interval with the interpolation interval size TS. The calculation of the contraction mapping function wi(S) is performed, for example, using a calculation algorithm of the contraction mapping function wi(S) in one of known techniques of FIF (Fractal Interpolation Functions) described above. Next, the mapping processing unit 2123 performs the contraction mapping such that each feature point extracted by the feature point extraction unit from the block is mapped into each interpolation interval with the interpolation interval size TS in the block in each block with the block size BS of the low-frequency audio signal S using the contraction mapping function wi(S) calculated by the contraction mapping function calculation unit 2122 for the interpolation interval, for each interpolation interval and for each block, and the mapping processing unit 2123 outputs a resultant mapped signal as an intermediate low-frequency sound sensation enhancement signal D.

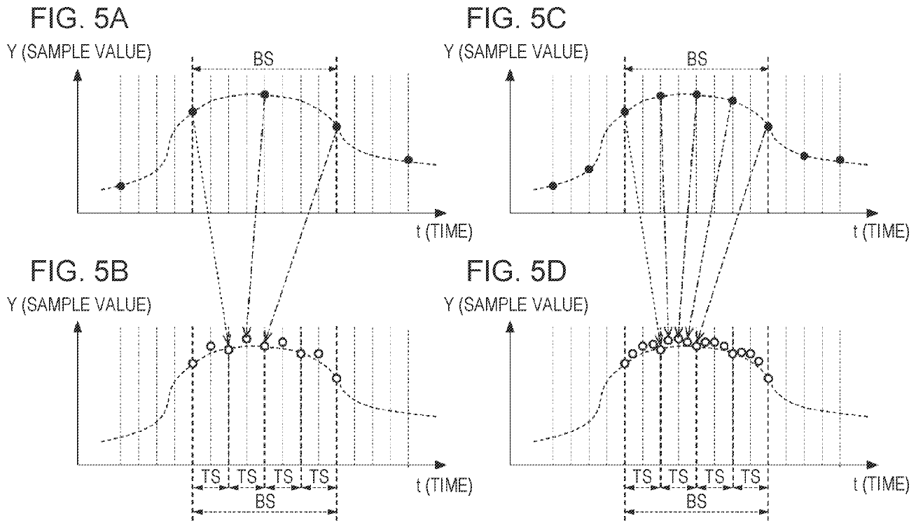

For example, in a case where three feature points are extracted from each block with a block size BS, as shown in FIG. 5A, and each block is divided into four interpolation intervals with an interpolation interval size TS as shown in FIG. 5B, the three feature points in each block are mapped, by contraction mapping, into each interpolation interval using the contraction mapping function wi(S) as represented by arrows directed from FIG. 4A to FIG. 4B.

For example, in a case where five feature points are extracted from each block with a block size BS, as shown in FIG. 5C, and each block is divided into four interpolation intervals with an interpolation interval size TS as shown in FIG. 5D, the five feature points in each block are mapped by contraction mapping into each interpolation interval using the contraction mapping function wi(S) as represented by arrows directed from FIG. 5C to FIG. 5D.

That is, the intermediate low-frequency sound sensation enhancement signal D generated in the above-described manner is a signal obtained by contracting the original low-frequency audio signal in the time domain by a ratio of TS/BS, and the intermediate low-frequency sound sensation enhancement signal D has a frequency range with an upper limit higher than f0 and provides a sound having a self-similarity to the sound of the low-frequency range audio signal S.

One form of the present disclosure has been described above. As described above, the low-frequency sound sensation enhancement signal C added to the audio source signal A to enhance the low-frequency sound sensation is generated by the FIF (Fractal Interpolation Functions) from the low-frequency components, outside the reproduction frequency range of the loudspeaker 3, of the audio source signal A such that the resultant low-frequency sound sensation enhancement signal C has self-similarity to the low-frequency components and has a frequency range within the reproduction frequency range of the loudspeaker 3. Accordingly, it is possible to enhance the low-frequency sound sensation such that a more natural sound sensation is achieved.

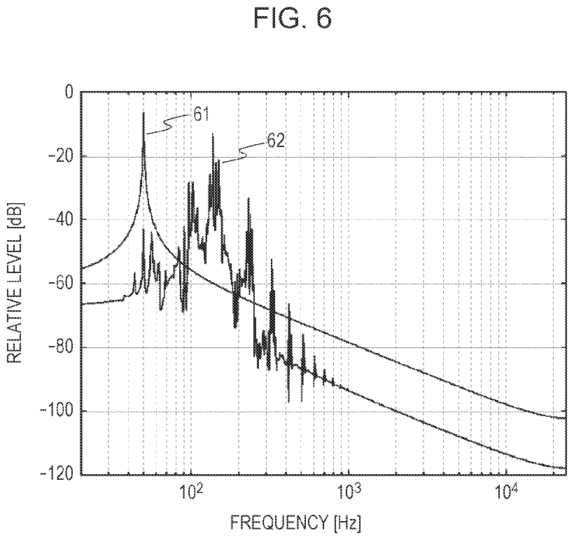

For example, FIG. 6 shows an intermediate low-frequency sound sensation enhancement signal 62 generated by the FIF processor 212 from a sine wave 61 of 50 Hz for a case where FS=48000 Hz, I=512, BS=1024, and TS=3. As shown in FIG. 6, compared to mere overtones of the sine wave 61, a not-unnatural signal having components dispersed over a wide frequency range is obtained as the intermediate low-frequency sound sensation enhancement signal 62.

Note that in FIG. 6, the vertical axis is represented in decibel dB, and the horizontal axis represents a frequency in Hz.

Although embodiments and implementations of the present disclosure have been described in detail above, the present disclosure is not limited to the specific embodiments, and various modifications and changes can be made within the scope of the disclosure set forth in the claims. Therefore, it is intended that this disclosure not be limited to the particular embodiments disclosed, but that the disclosure will include all embodiments and implementations falling within the scope of the appended claims.

1. An audio signal processing apparatus configured to add, to an input audio signal, a low-frequency sound sensation enhancement signal for enhancing a low-frequency sound sensation of the audio signal and to output a resultant signal, the audio signal processing apparatus comprising:
a low-frequency sound sensation enhancement signal generation unit configured to generate the low-frequency sound sensation enhancement signal from the input audio signal; and
a mixing unit configured to mix the low-frequency sound sensation enhancement signal with the input audio signal and to output a resultant mixed signal,
wherein the low-frequency sound sensation enhancement signal generation unit is configured to generate the low-frequency sound sensation enhancement signal by contraction mapping of components in a low-frequency range of the input audio signal using Fractal Interpolation Functions (FIF).

2. An audio system comprising:
an audio device configured to output an audio signal;
a loudspeaker; and
an audio signal processing apparatus configured to add, to the audio signal output by the audio device, a low-frequency sound sensation enhancement signal for enhancing a low-frequency sound sensation of the audio signal and output a resultant signal,
wherein the audio signal processing apparatus comprises:
a low-frequency sound sensation enhancement signal generation unit configured to generate the low-frequency sound sensation enhancement signal from the audio signal output by the audio device; and
a mixing unit configured to mix the low-frequency sound sensation enhancement signal with the audio signal output by the audio device and to output a resultant mixed signal to the loudspeaker,
wherein the low-frequency sound sensation enhancement signal generation unit is configured to generate the low-frequency sound sensation enhancement signal with a frequency range from f0 to f1, where f0<f1, by contraction mapping of components in a frequency range lower than fb of the audio signal output by the audio device using Fractal Interpolation Functions (FIF) where fb is a lower limit of a reproduction frequency range of the loudspeaker.

3. The audio system according to claim 2, wherein the low-frequency sound sensation enhancement signal generation unit is configured to extract data of the audio signal with a sampling rate of FS output by the audio device such that one piece of data is extracted as a feature point every I pieces of data, and to perform contraction mapping from each feature point in each block with a size BS into each interpolation interval with a size TS obtained by dividing the block such that following relationships are satisfied:
I≥FS(f0×2),
BS≥I×2,and
TS≤BS(f1/f0).

4. A method for enhancing a low-frequency sound sensation of an audio signal, comprising:
a step of generating a low-frequency sound sensation enhancement signal by contraction mapping of a component in a low-frequency range of the audio signal by Fractal Interpolation Functions (FIF); and
a step of mixing the low-frequency sound sensation enhancement signal with the audio signal and outputting a resultant mixed signal.
